(19) United States
(12) Patent Application Publication
(10) Pub. No.: US 2023/0125286 A1
(43) Pub. Date: Apr. 27, 2023

(54) DISPLAYING A PRODUCT IN A SELECTED ENVIRONMENT

(71) Applicant: Home Franchise Concepts LLC, Irvine, CA (US)

(72) Inventor: Faisal KHAN, Irvine, CA (US)

(21) Appl. No.: 18/048,269

(22) Filed: Oct. 20, 2022

Related U.S. Application Data
(60) Provisional application No. 63/379,858, filed on Oct. 17, 2022.
(60) Provisional application No. 63/270,156, filed on Oct. 21, 2021.

(51) Int. Cl. G06T 19/00; G06T 15/02; G06T 19/20; G06V 20/20; G06Q 30/0601

(52) U.S. Cl. CPC G06T 19/006; G06T 15/02; G06T 19/20; G06V 20/20; G06Q 30/0643; G06T 2210/62; G06T 2219/2004; G06T 2219/2016; G06T 2200/24

(57) ABSTRACT

Disclosed herein are a system and method for displaying a product in a selected environment of a customer. In one aspect, the method comprises, scanning, using a user device, a selected environment to obtain an image of the selected environment, processing the obtained image and creating a 3D image of the selected environment, selecting a product for displaying, generating, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view, and rendering the augmented reality 3D image onto a 2D display device.

### CROSS-REFERENCE TO RELATED APPLICATIONS

This application claims the benefits of U.S. Provisional Application No. 63/379,858, entitled “DISPLAYING A PRODUCT IN A SELECTED ENVIRONMENT”, filed on Oct. 17, 2022 and U.S. Provisional Application No. 63/270,156, entitled “DISPLAYING A PRODUCT IN A SELECTED ENVIRONMENT,” filed on Oct. 21, 2021, and hereby incorporates by reference herein the entire contents of each of these priority applications.

### FIELD OF TECHNOLOGY

Aspects of the present disclosure relate to the field of displaying products in a selected environment. Specifically, aspects of the present disclosure are directed to a system and method for displaying window blinds, decorative objects, etc., in a selected environment, such as a window, wall, surface, and the like.

### BACKGROUND

A business may need to inspire customers to purchase its products. One way is to provide catalogs, online views, etc. Another approach is to provide demos of the product being displayed in an exemplary environment. However, the exemplary environment may not be similar to the environment of the customers. Even if the customer procures the product, it may be unsatisfactory after being installed in a customer's home. For example, comparing a window blind installed in a model home environment with another one installed in a customer's home may not be practical for many reasons. For instance, the coloring of the room, the lighting, other objects in the room, etc. will affect the appearance. Moreover, people have different preferences/tastes.

Therefore, there remains an unmet need for displaying a product to a customer in the customer's environment such that the customer is able to visualize how the product would appear after installation.

### SUMMARY

Aspects of the disclosure relate to displaying products in a selected environment. For example, for displaying a blind on a selected window of a customer, and/or for displaying a cabinet product on a kitchen wall of a customer.

In one example aspect, a system for displaying a product in a selected environment of a customer is provided. The system comprises: a processor of a user device configured to: scan a selected environment to obtain an image of the selected environment, process the obtained image and create a 3D image of the selected environment, select a product for displaying, generate, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view, and render the augmented reality 3D image onto a 2D display device.

In one example aspect, the method further comprises: determining whether or not a second user selected view is received; when the second user selected view is received, modifying the augmented reality 3D image based on the second user selected view; and rendering the modified augmented reality 3D image on to the 2D display device.

In one example aspect, the user selected view includes at least one of: a selection of a viewing direction and angle, a selection of a lighting setting of the selected environment, a selection of transparency of the product when anchored to the 3D image of the selected environment, and a selection of anchoring position (e.g., inside window frame or outside window frame).

In one example aspect, when the product is a cabinet, the user selected view includes at least one of: a selection of a product type (e.g., types of cabinets), a selection of a product style (e.g., shaker, recessed, slab, raised), a selection of a finish type (e.g., color, stain, and the like), and a selection of cabinet hardware, a selection of finish for the cabinet hardware), among others.

In one example aspect, the user selected view further includes selections of countertops.

In one example aspect, the user selected view includes a combination of the selectable options for multiple products, e.g., for any combination of window blinds, cabinets, and countertops.

In one example aspect, a level of transparency of the product and portions of the product on which the transparency is to be applied are selected via the user device.

In one example aspect, the scaling of the 3D image of the selected product and the anchoring are performed based on user input indicating a plurality of vertices of the selected environment.

In one example aspect, the plurality of vertices includes at least two vertices of a rectangle, a diagonal of the rectangle connecting the at least two vertices.

In one example aspect, the processing of the obtained image comprises: gathering information about the selected environment including a distance between the user device and the selected environment and lighting information of the selected environment.

In one example aspect, the determined information about the selected environment further comprising at least one of: directional information (position and angle in 3D), shape information, and dimensional information.

In one example aspect, the user device comprises a LiDAR (light detection and ranging), sonar, or radar capable component usable for determination of the distance between the user device and the selected environment.

In one example aspect, the generation of the 3D image of the selected environment is performed by: recognizing the selected environment; and determining a spatial relationship between the selected environment and the user device.

In one example aspect, the dimensions of the selected environment are recognized automatically.

In one example aspect, the dimensions of the selected environment are recognized based on: storing, in a database, a list of standard objects and corresponding dimensions; identifying an object from the list of standard objects, the identified object having the closest dimensions to the computed dimensions of the selected environment; and setting the dimensions of the selected environment as being equal to the dimensions of the identified object.

In one example aspect, machine learning techniques are used to identify the list of standard objects and corresponding dimensions.

In one example aspect, the selected environment comprises a window, door, a wall, a surface, or an object.

In one example aspect, the product to be displayed is selected from a catalog.

In one example aspect, the displaying of the product in the selected environment is performed by a customer or a supplier of the product to the customer.

In one example aspect, the scanning of the selected environment in performed within the application displaying the product.

In one example aspect, the images of the selected environment are uploaded to the user device.

In one example aspect, the method further comprises: enabling the customer to access the rendered augmented reality 3D image, wherein the access is based on permissions, passwords, authentication.

In one example aspect, the method further comprises: storing the rendered augmented reality 3D image for subsequent viewing.

In one example aspect, the method further comprises: outputting the rendered augmented reality 3D image to other computing devices, servers or applications.

In one example aspect, the selection of the product for displaying is based on at least one of: a selection by the customer, a preference of the customer, and an input from another server or application.

According to one example aspect of the disclosure, a method is provided for displaying a product in a selected environment of a customer, the method comprising: scanning, using a user device, a selected environment to obtain an image of the selected environment, processing the obtained image and creating a 3D image of the selected environment, selecting a product for displaying, generating, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view, and rendering the augmented reality 3D image onto a 2D display device.

In one example aspect, a non-transitory computer-readable medium is provided storing a set of instructions thereon for displaying a product in a selected environment of a customer, wherein the set of instructions comprises instructions for: scanning, using a user device, a selected environment to obtain an image of the selected environment, processing the obtained image and creating a 3D image of the selected environment, selecting a product for displaying, generating, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view, and rendering the augmented reality 3D image onto a 2D display device.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example representative block diagram of a system for displaying a product in a selected environment, in accordance with aspects of the present disclosure.

FIG. 2 illustrates a flowchart of an example method for displaying a product in a selected environment, in accordance with aspects of the present disclosure.

FIGS. 3A-3D show screenshots for an example GUI implementation in accordance with aspects of the present disclosure.

FIG. 4 illustrates an example representative block diagram of an alternative system for displaying a product in a selected environment, in accordance with aspects of the present disclosure.

FIG. 5 presents a representative diagram of an example of various components and features of a general purpose computer system usable or incorporable with various features in accordance with aspects of the present disclosure.

FIG. 6 is a block diagram of various example system components, usable in accordance with aspects of the present disclosure.

### DETAILED DESCRIPTION

Example aspects are described herein in the context of an apparatus, system, method, and various computer program features for displaying a product in a selected environment, in accordance with aspects of the present disclosure. Those of ordinary skill in the art will realize that the following description is illustrative only and is not intended to be the only embodiment of the teachings in accordance with aspects of the present disclosure. Other aspects will readily suggest themselves to those skilled in the art having the benefit of the disclosure. Reference will now be made in detail to example implementations of various aspects as illustrated in the accompanying drawings. The same or similar reference indicators will be used to the extent possible throughout the drawings and the following description to refer to the same or like items. Accordingly, a detailed description of at least one preferred embodiment is provided herein.

The system comprises: a user device, configurable to scan a selected environment to obtain an image of the selected environment, process the obtained image and create a 3D image of the selected environment, select a product for displaying, wherein images of the product are rendered for any number of user selectable views and stored in a database a priori, generate, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view, and render the augmented reality 3D image onto a 2D display device (e.g., via an iPad or other terminal).

In one aspect, the user device includes a LiDAR (light detection and ranging), Sonar, Radar-like or other component capable of determining a 3D spatial relationship between the selected environment and the user device. For example, if the selected environment is a window in a room of a customer, a LiDAR sensor may be used to determine the distance between the window and the user device as well as lighting conditions in the room. The scanned image may then be used to create a 3D image of the window. Then, when a product is selected for being displayed, images of the product are obtained.

In one aspect, images of the product are rendered for various views and stored in a database. For instance, a customer may choose to view the product at different angles, in different lighting conditions, etc. Thus, in order to reduce the amount of time needed for displaying an image, the method stores previously rendered images for various user selectable views. When a customer selects a given angle, a given distance, lighting, etc., a particular image is presented. In order to ensure that a smooth transition is simulated when a different view is selected, images associated with a large number of scenarios are stored. Moreover, if a customer selected a view that is not a match to a previously stored image, smoothing techniques can be used.

In one aspect, the product may be semi-transparent. For example, a window blind may be made of semi-transparent material. The displaying of the product in the selected environment may include displaying the product as it would appear after installation. For instance, a blind made of semi-transparent material may be displayed for a window having objects located behind the window. In that case, displaying the blind in accordance with aspects of the present disclosure includes showing outlines and/or objects behind the window, such as trees and buildings, among other objects. Therefore, the previously stored images may include the features for displaying the product in according to a selected level of transparency.

In one aspect, the product may include a plurality of components suitable for visualizing together as the product would appear after installation. For example, if the customer is interested in kitchen cabinets, the plurality of components may include countertop products, various types of cabinets, knobs, and pulls. Images of the various components may then be superimposed onto the 3D image of the kitchen wall or a surface. The augmented reality 3D image may be at scale and anchored to the 3D image of the selected environment based on the location of the selected environment in relation to the location of the user device and the first user selected view. Then, the augmented reality 3D image may be rendered onto a 2D display device for displaying to the user.

In one aspect, selected portions of the product may be semi-transparent. For example, a first portion of a window blind may be semi-transparent while a second portion is opaque. In another example, the user may be able to select which portions are to be displayed semi-transparently.

In another aspect, a level of semi-transparency may be selectable. For example, there may be semi-transparency ranging from entirely see-through to entirely opaque that the user selects. Then, the product may be displayed according to the selected level of semi-transparency.

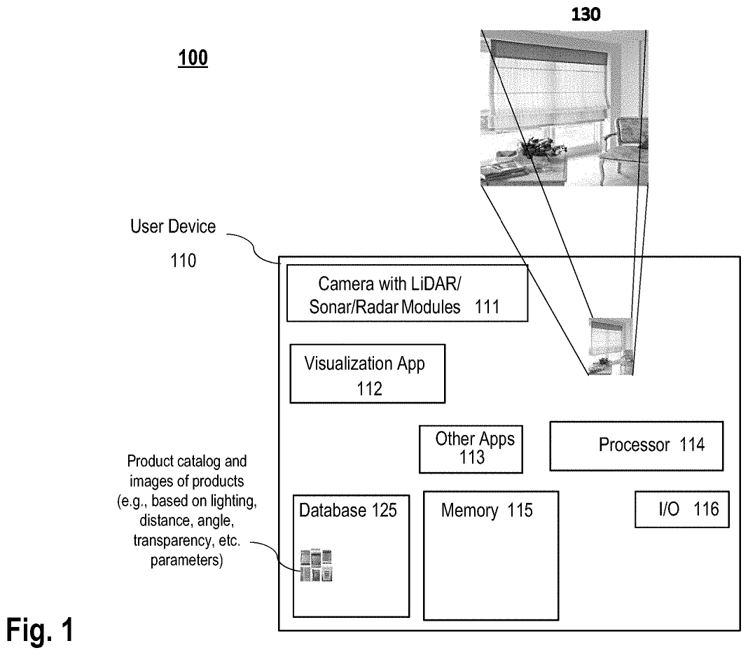

FIG. 1 illustrates an example representative block diagram of a system 100 for displaying a product in a selected environment, in accordance with aspects of the present disclosure. The system 100 shown in this example comprises a user device 110 that comprises a processor 114, memory 115 and I/O interface modules 116. For example, the user device 110 may be an iPad, iPhone, etc.

The user device 110 may further include a module for determining a spatial relationship between an object and the user device 110. For example, the spatial relationship may include distance, angle, etc., measurements between a window (i.e., the object) and the user device 110. In one aspect, the module for determining the spatial relationship may comprise a camera, LiDAR, sonar, or radar module 111.

The user device 110 may further comprise a visualization application 112 of the present disclosure for displaying a product. Thus, the product may be displayed on a screen of the same device 110. The visualization application 112 may interact with a database 125 to store and/or retrieve information needed for displaying the product, as needed. FIG. 1 further illustrates an expanded view 130 of the product being displayed in accordance with aspects of the present disclosure.

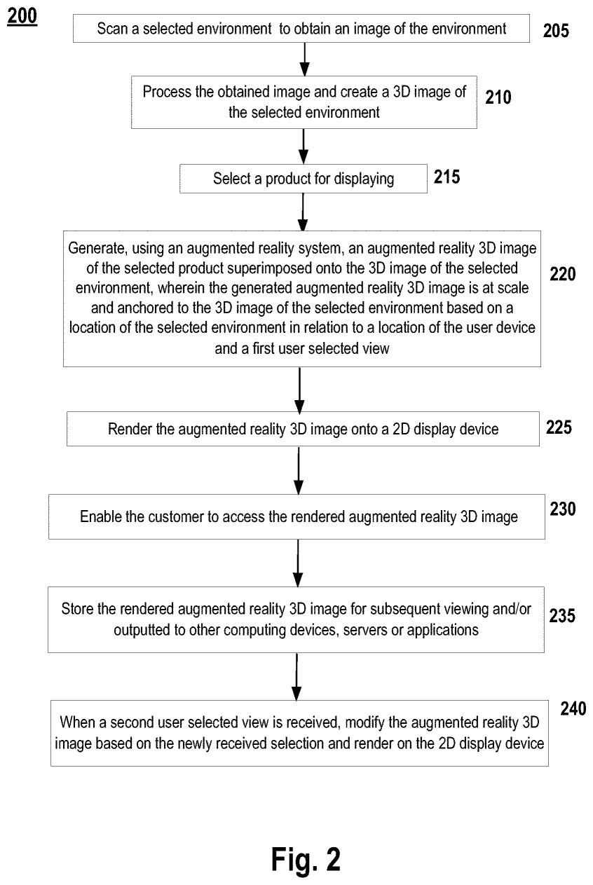

FIG. 2 illustrates a flowchart of an example method 200 for displaying a product in a selected environment in accordance with aspects of the present disclosure. The method 200 may be implemented in a user device, for example, the device 110, as shown and discussed with regard to FIG. 1 above. For example, the application may be installed on an iPhone, iPad or similar device.

In step 205, a selected environment may be scanned to obtain an image of the environment. For example, a user device with a LiDAR sensor may be used to perform the scanning.

In step 210, the obtained image may be processed, and a 3D image of the selected environment may be created.

In step 215, a product may be selected for displaying. In one aspect, images of the product may be rendered for any number of user selectable views and stored in a database a priori, i.e., before the selection. Thus, when the selection is made, the displaying can be performed without excessive delay.

In step 220, an augmented reality 3D image of the selected product superimposed onto the 3D image of the selected environment is generated using an augmented reality system. The generated augmented reality 3D image may be at scale and anchored to the 3D image of the selected environment based on a location of the selected environment in relation to a location of the user device and a user selected view.

In step 225, the augmented reality 3D image may be rendered onto a 2D display device.

In optional step 230, the customer is enabled to access the rendered augmented reality 3D image. In order to add data security, the access may be based on authentication, permission, and passwords.

In optional step 235, the rendered augmented reality 3D image may be stored for subsequent viewing and/or outputted to other computing devices, servers or applications.

In optional step 240, a determination may be made as to whether or not a second user selected view is received. When the second user selected view is received, the augmented reality 3D image may be modified based on the newly received selection and rendered on the 2D display device. The method may then end until another session for displaying a product is invoked.

In one aspect, the user selected view may include at least one of: a selection of a viewing direction and angle, a selection of a lighting setting of the selected environment, a selection of transparency of the product when anchored to the 3D image of the selected environment, and a selection of anchoring position (inside window frame or outside window frame).

In one aspect, a level of transparency of the product and portions of the product on which the transparency is to be applied may be selected via the user device.

In one aspect, the scaling of the 3D image of the selected product and the anchoring may be performed based on user input indicating a plurality of vertices of the selected environment.

In one aspect, the plurality of vertices may include at least two vertices of a rectangle, a diagonal of the rectangle connecting the at least two vertices.

In one aspect, the processing of the obtained image may comprise: gathering information about the selected environment including a distance between the user device and the selected environment and lighting information of the selected environment.

In one aspect, the determined information about the selected environment may further comprise at least one of: directional information (position and angle in 3D), shape information, and dimensional information.

In one aspect, the user device may comprise a LiDAR, sonar, radar-like or other component capable of determining the distance between the user device and the selected environment.

In one aspect, the generation of the 3D image of the selected environment may be performed by: recognizing the selected environment; and determining a spatial relationship between the selected environment and the user device.

In one aspect, dimensions of the selected environment may be recognized automatically.

In one aspect, the dimensions of the selected environment may be recognized based on: storing, in a database, a list of standard objects and corresponding dimensions; identifying an object from the list of standard objects, the identified object having the closest dimensions to the computed dimensions of the selected environment; and setting the dimensions of the selected environment as being equal to the dimensions of the identified object.

In one aspect, machine learning techniques may be used to identify the list of standard objects and corresponding dimensions.

In one aspect, the selected environment may comprise a window, door, surface, wall, or an object, among other environments.

In one aspect, the product to be displayed may be selected from a catalog. In one example aspect, the selection of the product from the catalog may be performed by one or more of: navigating options based on a list of products (e.g., cabinets, blinds, among others), features (e.g., room darkening, light filtering, insulation, shutters, whether or not lift and tilt are desired), product categories (e.g., roller shades, wood blinds, woven, among others), navigating options based on product sub-categories (e.g., types of finishes of products, colors of products, transparency of products, among others), product descriptions, and interacting with displays of the products in the selected environment. For example, if the product is a window blind, the navigation options may include selecting among roller shades, dual roller shades, motorized versus manual, and the like. The navigation options for sub-categories may enable the user to select colors, materials, different levels of transparency of the shades, among others. The user may then navigate to view a product description, e.g., a video presentation or a document describing the selected product. Similarly, if the product is a cabinet, the user may select a type of cabinet (e.g., solid wood door, see-through glass door), finish type, cabinet hardware, finish type for cabinet hardware, colors for the cabinet and hardware, among others.

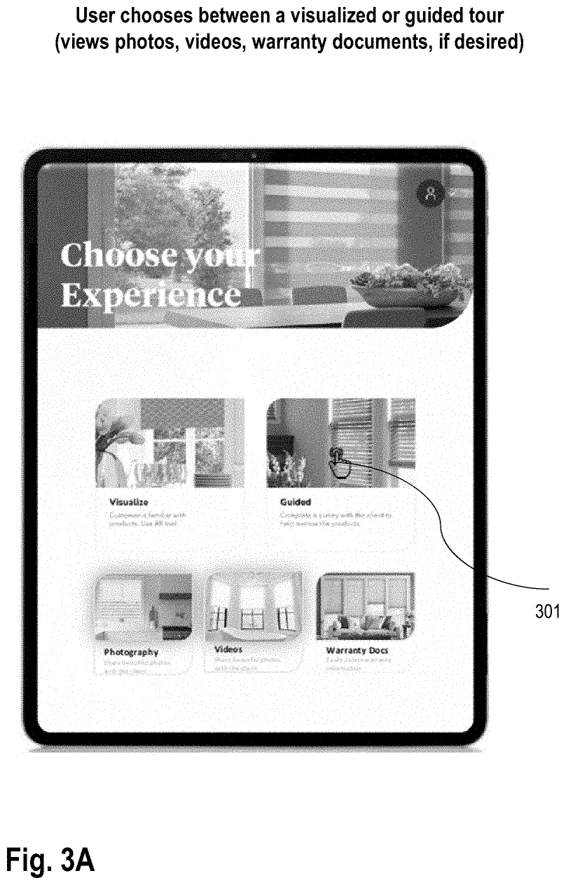

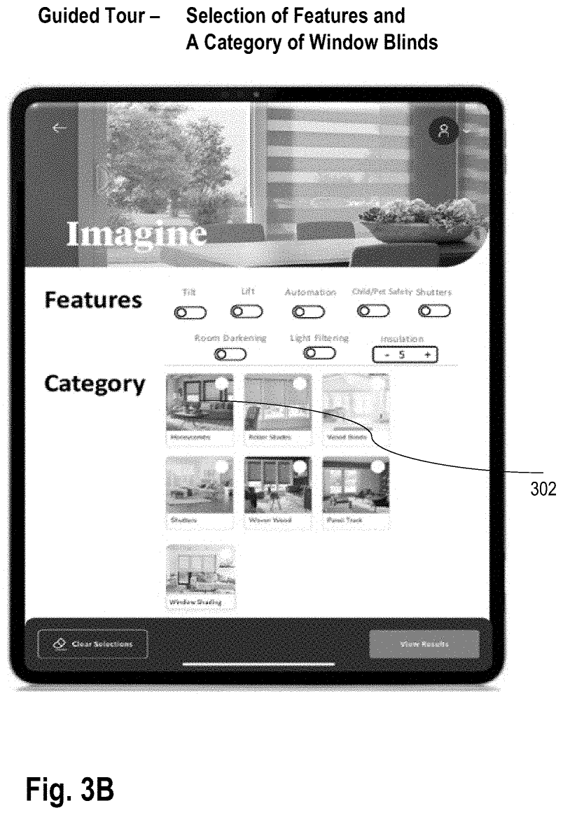

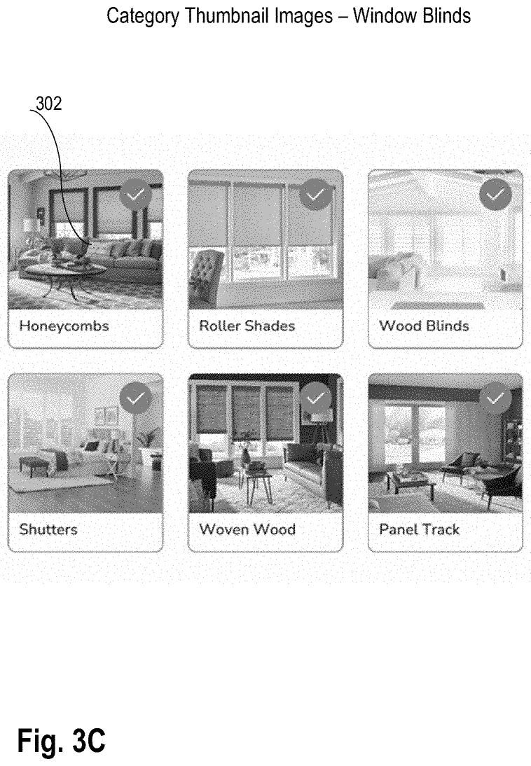

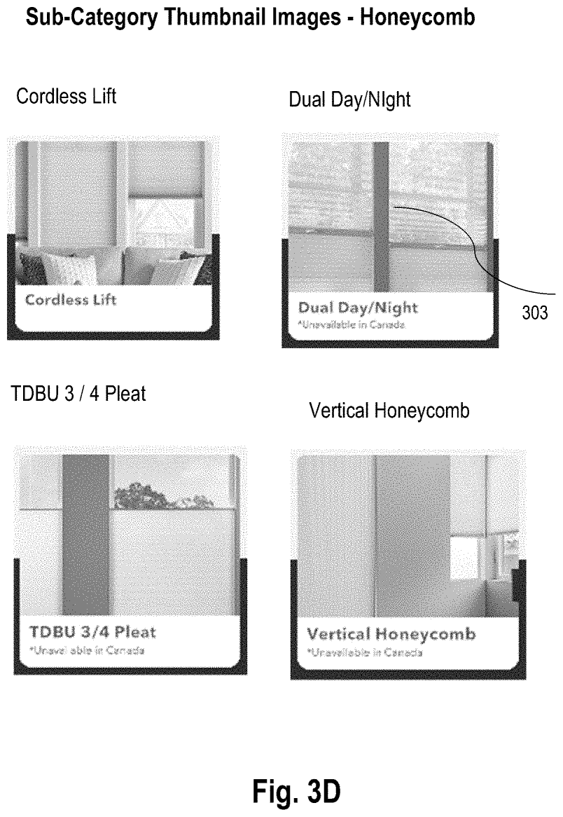

FIGS. 3A-3D show screenshots for an example GUI implementation in accordance with aspects of the present disclosure. For example, the user chooses between a visualized or guided tour, as shown in FIG. 3A. If the user chooses the guided tour 301, then the user may be directed to or able to select to access, for example, another screen to select a category. The user may then select features and categories of products, as shown in FIG. 3B. FIG. 3C shows another view of the categories of products available for window blinds in this example implementation. Further, if the user chooses the Honeycomb 302, for example, the user may be directed to another screen that may enable the user to choose sub-categories, as shown in FIG. 3D. The user may then select form the sub-categories available for Honeycomb. If the user chooses the Dual Day/Night Honeycomb sub-category 303, for example, then the user may then be directed to or may be provided with an option to select images, videos, other information related to the selected product, for example.

In one example aspect, the GUI implementation may include any number of layers, allowing additional selection options, such as selections based on color, manufacturer, warranty, and the like.

In one aspect, the displaying of the product in the selected environment may be performed by a customer or a supplier of the product to the customer.

In one aspect, the scanning of the selected environment may be performed within the application displaying the product.

In one aspect, the images of the selected environment may be uploaded to the user device.

In one aspect, the selection of the product for displaying may be based on at least one of: a selection by the customer, a preference of the customer (previous browsing history, URLs visited, etc.), and an input from another server or application (input from sales).

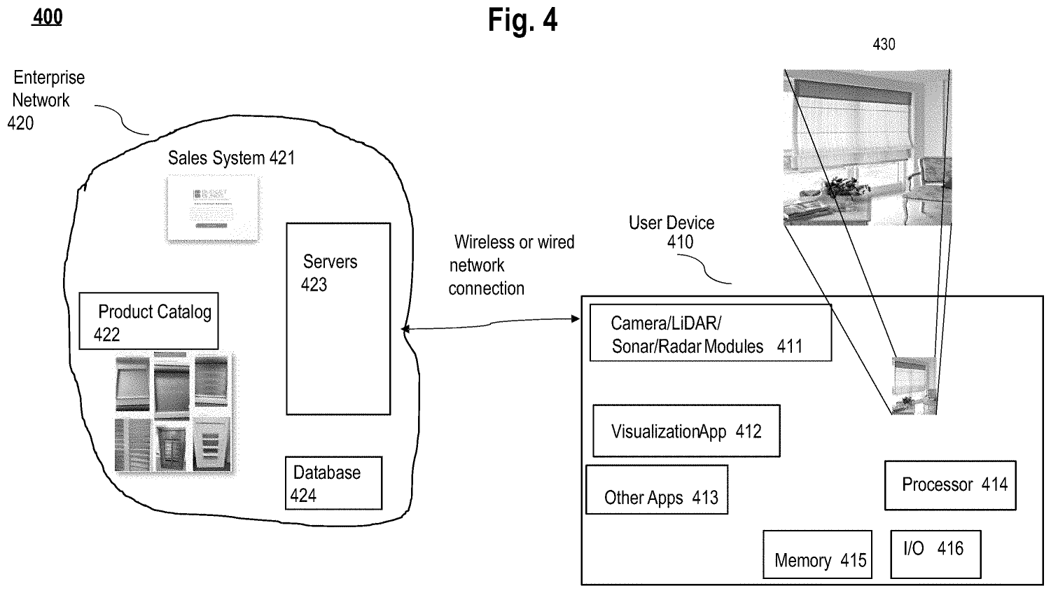

FIG. 4 illustrates an example representative block diagram of an alternative system 400 for displaying a product in a selected environment, in accordance with aspects of the present disclosure. The system 400 shown in this example comprises: a user device 410, an enterprise network 420. The user device 410 may include a module for determining a spatial relationship between an object and the user device 410. For example, the spatial relationship may include distance, angle, etc., measurements between a window (i.e., the object) and the user device 410. In one aspect, the module for determining the spatial relationship may comprise a camera, LiDAR, sonar, or radar module 411. The user device 410 may further comprise the visualization application 412 of the present disclosure for displaying a product. The product may be displayed on a screen of the same device 410. FIG. 4 illustrates an expanded view 430 of the product being displayed in accordance with aspects of the present disclosure.

The user device 410 further may comprise a processor 414, memory 415 and I/O interface modules 416. For example, the user device 410 may be an iPad, iPhone, or like device on which the visualization application 412 may be installed. The visualization application 412 may interact with enterprise network 420. The enterprise network 420 may include several components, such as a sales system 421, product catalog database 422, servers 423, and databases 424, among other components. The visualization application 412 and the other applications 413 may store and/or retrieve information from the enterprise network 420, as needed.

The visualization application 112 of the present disclosure for displaying a product in accordance with one example implementation, as shown, may, among other advantages, enable inspiration of customers by users (e.g., franchisees selling products). The visualization application 112 may enable such users (or the customers themselves as users) to obtain an image of windows, walls, or doors, choose products from a product catalog, and digitally view the blinds, cabinets, and/or other features in a 3D image on a user device, such as an iPad or other terminal—thereby allowing customers to view an image of how the product may appear in their home. Moreover, the visualization application may be implemented as a reusable platform that may be utilized by any suitable franchise-driven or other business for displaying products in a selected environment.

In one example aspect, the 3D visualization experience may include: a 4-corner tap (or other selection) experience, a pinch and zoom experience, and/or an instant modeling experience. In one example aspect, the 4-corner tap experience enables a user to hold a device (e.g., iPad or other terminal) up to the environment (e.g., window, wall) and to tap or otherwise select the 4-corners of the environment to set the product onto the selected environment. In one example aspect, the 4-corner tap experience may be used as a tool for precise measurement of the environment for use during 3D modeling, for example. The results of the 3D modeling may then be virtually overlaid onto the selected environment and rendered to be displayed on a 2D device, for example.

In one example aspect, the pinch and zoom experience may enable the user to hold the device (e.g., iPad or other terminal) up to the environment (e.g., window) and to tap the middle (or other area) of the selected environment. A 3D product then may appear on the selected environment, and the user may then pinch and expand, for example, the 3D product to fit the environment to scale. This experience may be used to increase engagement of the customer in the process, among other advantages.

In one example aspect, the instant modeling experience may enable the user to walk into a room of a customer, for example, hold the device up to enable a visualization application to recognize the environment (e.g., a window, door), and snap a 3D image of a selected product to scale onto the environment without the user touching the screen of the device. In one aspect, machine learning may be used by the visualization application for assisting, in recognizing the environment and/or carrying out such features above.

Appendices that illustrate various aspects of an example implementation in accordance with aspects of the present disclosure are attached. Shown in the attached are an example Product Implementation Overview, Application Narrative, 3D Visualization Aspects, Additional Features Visualization, ProView Product and Enhancements, and example Kitchen Tune Up - Product vision screens.

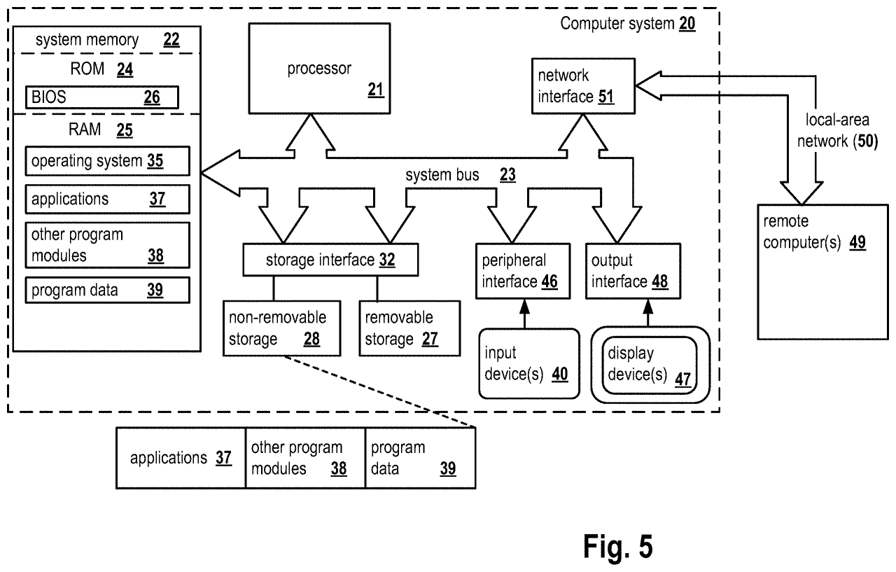

FIG. 5 is a block diagram illustrating various components of an example computer system 20 via which aspects of the present disclosure for displaying products in a selected environment may be implemented. The computer system 20 may, for example, be or include a computing system of the user device, or may comprise a separate computing device communicatively coupled to the user device, etc. In addition, the computer system 20 may be in the form of multiple computing devices, or in the form of a single computing device, including, for example, a mobile computing device, a cellular telephone, a smart phone, a desktop computer, a notebook computer, a laptop computer, a tablet computer, a server, a mainframe, an embedded device, and other forms of computing devices.

As shown in FIG. 5, the computer system 20 may include one or more central processing units (CPUs) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) may include a single or multiple sets of processors having single or multiple cores. The processor 21 may execute one or more computer-executable lines of code implementing techniques in accordance with aspects of the present disclosure. The system memory 22 may be or include any memory for storing data used herein and/or computer programs that are executable via the processor 21. The system memory 22 may include volatile memory, such as a random access memory (RAM) 25 and non-volatile memory, such as a read only memory (ROM) 24, flash memory, etc., or any combination thereof. The basic input/output system (BIOS) 26 may store the basic procedures for transfer of information among elements of the computer system 20, such as those at the time of loading the operating system with the use of the ROM 24.

The computer system 20 may include one or more storage devices, such as one or more removable storage devices 27, one or more non-removable storage devices 28, or a combination thereof. The one or more removable storage devices 27 and non-removable storage devices 28 may be coupled to the system bus 23 via a storage interface 32. In an aspect, the storage devices and the corresponding computer-readable storage media may be or include power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory, such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology, such as in solid state drives (SSDs) or flash drives; magnetic cassettes, magnetic tape, and magnetic disk storage, such as in hard disk drives or floppy disks; optical storage, such as in compact disks (CD-ROM) or digital versatile disks (DVDs); and any other medium that may be used to store the desired data and that may be accessed via the computer system 20.

The system memory 22, removable storage devices 27, and/or non-removable storage devices 28 of the computer system 20 may be used to store an operating system 35, additional program applications 37, other program modules 38, and/or program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47, such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

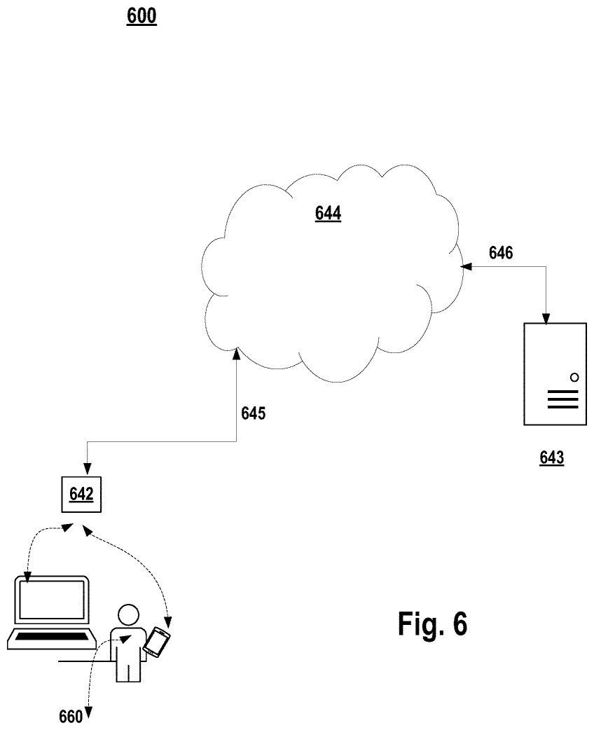

The computer system 20 may operate in a network environment as shown in FIG. 6, using a network connection to one or more remote computers 49. The remote computer (or computers) 49 may be or include local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks, such as a local-area computer network (LAN) 50, a wide-area computer network (WAN), an intranet, and the Internet. Examples of the network interface 51 may include an Ethernet interface, a Frame Relay interface, SONET interface, and wireless interfaces.

FIG. 6 is a block diagram of various example system components, usable in accordance with aspects of the present disclosure. FIG. 6 shows a communication system 600 usable in accordance with aspects of the present disclosure. The communication system 600 includes one or more accessors 660 (also referred to interchangeably herein as one or more “users”) and one or more terminals 642. In one aspect, data for use in accordance with aspects of the present disclosure may, for example, be input and/or accessed by accessors 660 via terminals 642, such as personal computers (PCs), minicomputers, mainframe computers, microcomputers, telephonic devices, or wireless devices, such as personal digital assistants (“PDAs”), smart phones, or other hand-held wireless devices coupled to a server 643, such as a PC, minicomputer, mainframe computer, microcomputer, or other device having a processor and a repository for data and/or connection to a repository for data, via, for example, a network 644, such as the Internet or an intranet, and couplings 645, 646. In one aspect, various features of the method may be performed in accordance with a command received from another device via a coupling 645, 646. The couplings 645, 646 may include, for example, wired, wireless, or fiberoptic links. In another variation, various features of the method and system in accordance with aspects of the present disclosure may operate in a stand-alone environment, such as on a single terminal. In one aspect, the server 543 may be a remote computer 49, as shown in FIG. 5, or a local server.

Aspects of the present disclosure may be or include a system, a method, and/or a computer program product. The computer program product may include a computer readable storage medium (or media) having computer readable program instructions thereon for causing a processor to carry out aspects of the present disclosure.

The computer readable storage medium may be or include a tangible device that may retain and store program code in the form of instructions or data structures that may be accessed via a processor of a computing device, such as the computing system 20. The computer readable storage medium may be or include an electronic storage device, a magnetic storage device, an optical storage device, an electromagnetic storage device, a semiconductor storage device, or any suitable combination thereof. By way of example, such computer-readable storage medium may comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device, such as punch-cards or raised structures in a groove having instructions recorded thereon. As used herein, a computer readable storage medium is not to be construed as being or only being transitory signals per se, such as radio waves or other freely propagating electromagnetic waves, electromagnetic waves propagating through a waveguide or transmission media, or electrical signals transmitted through a wire.

Computer readable program instructions described herein may be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations in accordance with aspects of the present disclosure may be or include assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be coupled to the user's computer via any suitable type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform various functions in accordance with aspects of the present disclosure.

In various aspects, the systems and methods described in the present disclosure may be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation shown or described as an example herein.

In the interest of clarity, not all of the routine features of the aspects are disclosed herein. It will be appreciated that in the development of any actual implementation of features in accordance with aspects of the present disclosure, numerous implementation-specific decisions may be made in order to achieve the developer's specific goals, and these specific goals may vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of various features in accordance with aspects of the present specification are to be interpreted by one of ordinary skil in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it will be apparent to those skilled in the art having the benefit of this disclosure that many more modifications than mentioned above are possible without departing from the innovative concepts disclosed herein.

1. A method for displaying a product in a selected environment of a customer, the method comprising:
scanning, using a user device, a selected environment to obtain an image of the selected environment;
processing the obtained image and creating a 3D image of the selected environment;
selecting a product for displaying, wherein images of the product are rendered for a plurality of user selectable views and stored in a database a priori;
generating, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view; and
rendering the augmented reality 3D image onto a 2D display device.

2. The method of claim 1, further comprising:
determining whether or not a second user selected view is received;
when the second user selected view is received, modifying the augmented reality 3D image based on the second user selected view; and
rendering the modified augmented reality 3D image on to the 2D display device.

3. The method of claim 1, wherein the user selected view includes at least one of: a selection of a viewing direction and angle, a selection of a lighting setting of the selected environment, a selection of transparency of the product when anchored to the 3D image of the selected environment, and a selection of anchoring position.

4. The method of claim 3, wherein a level of transparency of the product and portions of the product on which the transparency is to be applied are selected via the user device.

5. The method of claim 1, wherein the scaling of the 3D image of the selected product and the anchoring are performed based on user input indicating a plurality of vertices of the selected environment.

6. The method of claim 5, wherein the plurality of vertices includes at least two vertices of a rectangle, a diagonal of the rectangle connecting the at least two vertices.

7. The method of claim 1, wherein the processing of the obtained image comprises: gathering information about the selected environment including a distance between the user device and the selected environment and lighting information of the selected environment.

8. The method of claim 1, the determined information about the selected environment further comprising at least one of: directional information, shape information, and dimensional information.

9. The method of claim 1, wherein the user device comprises a LiDAR (light detection and ranging), sonar, or radar capable component usable for determination of the distance between the user device and the selected environment.

10. The method of claim 1, wherein the generation of the 3D image of the selected environment is performed by:
recognizing the selected environment; and
determining a spatial relationship between the selected environment and the user device.

11. The method of claim 1, wherein dimensions of the selected environment are recognized automatically.

12. The method of claim 1, wherein the dimensions of the selected environment are recognized based on:
storing, in a database, a list of standard objects and corresponding dimensions;
identifying an object from the list of standard objects, the identified object having the closest dimensions to the computed dimensions of the selected environment; and
setting the dimensions of the selected environment as being equal to the dimensions of the identified object.

13. The method of claim 12, wherein machine learning techniques are used to identify the list of standard objects and corresponding dimensions.

14. The method of claim 1, wherein the selected environment comprises a window, door, a surface or an object.

15. The method of claim 1, wherein the product to be displayed is selected from a catalog.

16. The method of claim 1, wherein the displaying of the product in the selected environment is performed by a customer or a supplier of the product to the customer.

17. The method of claim 1, wherein the scanning of the selected environment in performed within the application displaying the product.

18. The method of claim 1, wherein the images of the selected environment are uploaded to the user device.

19. The method of claim 1, further comprising:
enabling the customer to access the rendered augmented reality 3D image, wherein the access is based on permissions, passwords, authentication.

20. The method of claim 1, further comprising: storing the rendered augmented reality 3D image for subsequent viewing.

21. The method of claim 1, further comprising:
outputting the rendered augmented reality 3D image to other computing devices, servers or applications.

22. The method of claim 1, wherein the selection of the product for displaying is based on at least one of: a selection by the customer, a preference of the customer, and an input from another server or application.

23. The method of claim 1, when the product is a cabinet, wherein the user selected view includes at least one of: a selection of a product type, a selection of a product style, a selection of a finish type, a selection of cabinet hardware, a selection of finish for the cabinet hardware.

24. A system of a user device for displaying a product in a selected environment of a customer, the system comprising:
a processor configured to:
scan a selected environment to obtain an image of the selected environment;
process the obtained image and creating a 3D image of the selected environment;
select a product for displaying, wherein images of the product are rendered for a plurality of user selectable views and stored in a database a priori;
generate, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view; and
render the augmented reality 3D image onto a 2D display device.

25. A non-transitory computer readable medium storing thereon computer executable instructions for displaying a product in a selected environment of a customer, including instructions for:
scanning, using a user device, a selected environment to obtain an image of the selected environment;
processing the obtained image and creating a 3D image of the selected environment;
selecting a product for displaying, wherein images of the product are rendered for a plurality of user selectable views and stored in a database a priori;
generating, using an augmented reality system, an augmented reality 3D image of the selected product superimposed onto the 3D image of the selected environment, wherein the generated augmented reality 3D image is at scale and anchored to the 3D image of the selected environment based on a location of the selected environment in relation to a location of the user device and a first user selected view; and
rendering the augmented reality 3D image onto a 2D display device.
